(19) United States
(12) Patent Application Publication
(10) Pub. No.: US 2025/0130128 A1
(43) Pub. Date: Apr. 24, 2025

(54) PRESSURE MONITOR FOR VEHICLE TIRE INFLATION

(71) Applicant: Chongqing Maiyi Technology Co., Ltd., Chongqing (CN)

(72) Inventor: Zhuo Chen, Chongqing (CN)

(21) Appl. No.: 18/918,179

(22) Filed: Oct. 17, 2024

(30) Foreign Application Priority Data
Oct. 19, 2023 (CN) 202322811999.5

(51) Int. Cl. G01L 17/00; G01L 19/00; G01L 19/08

(52) U.S. Cl. CPC G01L 17/00; G01L 19/003; G01L 19/083

(57) ABSTRACT

A pressure monitor for vehicle tire inflation includes a hollow hand-held portion, a pressure digital indicator, an airflow control valve sleeve, a quick fit interface, an inflation hose, a valve core joint assembly and an air relief valve, wherein the hollow hand-held portion has a top end threaded with the pressure digital indicator and a bottom end provided with a dual end threaded part, a lower portion of the dual end threaded part is threadably provided with the airflow control valve sleeve, an end of the airflow control valve sleeve is provided with the quick fit interface, the inflation hose is hermetically connected and provided at one side of a top portion of the hollow hand-held portion, an end of the inflation hose is provided with a quick connect threaded part, and the valve core joint assembly is provided at an end of the quick connect threaded part.

### CROSS-REFERENCE TO RELATED APPLICATION

The present disclosure claims the priority to the Chinese patent application with the filing No. 2023228119995 filed with the Chinese Patent Office on Oct. 19, 2023, and entitled “PRESSURE MONITOR FOR VEHICLE TIRE INFLATION”, the contents of which are incorporated herein by reference in entirety.

### TECHNICAL FIELD

The present disclosure belongs to the technical field of tire safety, and relates to a pressure monitor for vehicle tire inflation.

### BACKGROUND ART

Currently, there are three types of tire gauges for measuring and controlling vehicle tire pressure: pencil tire gauge, mechanical pointer tire gauge and electronic digital display tire gauge. In current pressure control methods, a pressure value can be measured by different tire gauges only after inflation is completed, but it is hard to manage and control the pressure in the inflation process. Too high and too low tire pressures can both shorten the service life of the tire, causing certain potential safety hazards.

Therefore, it is necessary to improve and design a pressure monitor for vehicle tire inflation.

### SUMMARY

Embodiments of the present disclosure provide a pressure monitor for vehicle tire inflation, including a hollow hand-held portion, a pressure digital indicator, an airflow control valve sleeve and an air relief valve, wherein a top end of the hollow hand-held portion is threadably provided with the pressure digital indicator, a bottom end of the hollow hand-held portion is provided with a dual end threaded part, a lower portion of the dual end threaded part is threadably provided with the airflow control valve sleeve, and the air relief valve is provided on an outer side of an upper portion of the hollow hand-held portion.

In one or more embodiments, the pressure monitor for vehicle tire inflation further includes a quick fit interface configured to be connected to an outside air pump, wherein an end of the airflow control valve sleeve is provided with the quick fit interface.

In one or more embodiments, the pressure monitor for vehicle tire inflation further includes an inflation hose, wherein the inflation hose is hermetically connected and provided at one side of a top portion of the hollow hand-held portion.

In one or more embodiments, the pressure monitor for vehicle tire inflation further includes a valve core joint assembly configured to be connected to an air nozzle of a vehicle tire, wherein an end of the inflation hose is provided with a quick connect threaded part, and the valve core joint assembly is provided at an end of the quick connect threaded part.

In one or more embodiments, the pressure digital indicator includes an aluminum shell, a back seat, a face shell, a pressure sensor, a control board and a display screen, wherein the back seat and the face shell are provided in the aluminum shell, the face shell is tightly connected to the back seat, the control board is provided in the back seat, a hollow connection terminal configured to communicate with the hollow hand-held portion is provided at a bottom end of the aluminum shell, the pressure sensor is provided in the hollow connection terminal, and the display screen is provided at an upper portion of the face shell.

In one or more embodiments, the pressure digital indicator further includes a battery compartment and a compartment cap, the battery compartment is provided on a rear end surface of the back seat, a back surface of the aluminum shell is provided with a battery assembling through-hole, and the compartment cap that is detachable is provided on the battery assembling through-hole.

In one or more embodiments, the face shell is provided thereon with a start switch and a backlight switch, and the start switch is located at one side of the backlight switch.

In one or more embodiments, a backlight lamp is provided at a bottom portion of the back seat, and the control board is electrically connected to the pressure sensor, the start switch, the backlight switch, the backlight lamp and the display screen.

In one or more embodiments, the airflow control valve sleeve includes a barrel, a control tube valve, a spring and a limiting clamp ring, wherein a top portion of the barrel is provided with an annular groove, the limiting clamp ring is sleeved in the annular groove, the control tube valve is sleeved outside the barrel, and the barrel is provided therein with the spring configured to abut and push the control tube valve.

In one or more embodiments, an inner side of an upper portion of the barrel is provided with an inner thread, and the inner thread of the barrel is hermetically connected with the dual end threaded part.

In one or more embodiments, the pressure monitor for vehicle tire inflation further includes a quick fit interface, wherein an end of the airflow control valve sleeve is provided with the quick fit interface, and an end of the barrel away from the top portion is connected to the quick fit interface.

In one or more embodiments, a side wall of a lower portion of the barrel is provided with an air hole, and a lower portion of an inner wall of the control tube valve is provide with a scaling ring configured to control opening and closing of the air hole, wherein the control tube valve is configured to be pushed downwards to close the air hole.

In one or more embodiments, the valve core joint assembly includes an air nozzle seat, a sealing rubber sheath and a valve threaded tube, the quick connect threaded part is hermetically threaded with one end of the air nozzle seat, and the other end of the air nozzle seat is integrally connected to a long tube core provided with a longitudinal groove.

In one or more embodiments, the sealing rubber sheath is sleeved over the long tube core, and the valve threaded tube is sleeved over an outer side surface of the sealing rubber sheath.

In or more embodiments, the hollow hand-held portion is made of an aluminum alloy.

Embodiments of the present disclosure further provide a pressure monitor for vehicle tire inflation, including a hollow hand-held portion, a pressure digital indicator, an airflow control valve sleeve, a quick fit interface, an inflation hose, a valve core joint assembly and an air relief valve, wherein a top end of the hollow hand-held portion is threadably provided with the pressure digital indicator, a bottom end of the hollow hand-held portion is provided with a dual end threaded part, a lower portion of the dual end threaded part is threadably provided with the airflow control valve sleeve, an end of the airflow control valve sleeve is provided with the quick fit interface, the inflation hose is hermetically connected and provided at one side of a top portion of the hollow hand-held portion, an end of the inflation hose is provided with a quick connect threaded part, the valve core joint assembly is provided at an end of the quick connect threaded part, and the air relief valve is provided on an outer side of an upper portion of the hollow hand-held portion.

In one or more embodiments, the pressure digital indicator includes an aluminum shell, a back seat, a face shell, a battery compartment, a compartment cap, a pressure sensor, a control board and a display screen, wherein the back seat and the face shell are provided in the aluminum shell, the face shell is tightly connected to the back seat, the control board is provided in the back seat, the battery compartment is provided on a rear end surface of the back seat, a back surface of the aluminum shell is provided with a battery assembling through-hole, the compartment cap that is detachable is provided on the battery assembling through-hole, a hollow connection terminal configured to communicate with the hollow hand-held portion is provided at a bottom end of the aluminum shell, the pressure sensor is provided in the hollow connection terminal, the face shell is provided thereon with a start switch and a backlight switch, the start switch is located at one side of the backlight switch, the display screen is provided at an upper portion of the face shell, a backlight lamp is provided at a bottom portion of the back seat, and the control board is electrically connected to the pressure sensor, the start switch, the backlight switch, the backlight lamp and the display screen.

In one or more embodiments, the airflow control valve sleeve includes a barrel, a control tube valve, a spring and a limiting clamp ring, wherein an inner side of an upper portion of the barrel is provided with an inner thread, the inner thread of the barrel is hermetically connected with the dual end threaded part, a top portion of the barrel is provided with an annular groove, the limiting clamp ring is sleeved in the annular groove, an end of the barrel away from the top portion is connected to the quick fit interface, the control tube valve is sleeved outside the barrel, the barrel is provided therein with the spring configured to abut and push the control tube valve, a side wall of a lower portion of the barrel is provided with an air hole, and a lower portion of an inner wall of the control tube valve is provided with a scaling ring configured to control opening and closing of the air hole, wherein the control tube valve is pushed downwards to close the air hole.

In one or more embodiments, the valve core joint assembly includes an air nozzle seat, a sealing rubber sheath and a valve threaded tube, the quick connect threaded part is hermetically threaded with one end of the air nozzle seat, the other end of the air nozzle seat is integrally connected to a long tube core provided with a longitudinal groove, the sealing rubber sheath is sleeved over the long tube core, and the valve threaded tube is sleeved over an outer side surface of the sealing rubber sheath.

In one or more embodiments, the hollow hand-held portion is made of an aluminum alloy.

### BRIEF DESCRIPTION OF DRAWINGS

FIG. 1 is a perspective structural schematic view of the present disclosure;

FIG. 2 is an exploded structural schematic view of the present disclosure;

FIG. 3 is a structural schematic view of a pressure digital indicator in the present disclosure;

FIG. 4 is a perspective structural schematic view of a back seat in the present disclosure;

FIG. 5 is an exploded structural schematic view of an airflow control valve sleeve in the present disclosure;

FIG. 6 is an exploded structural schematic view of a valve core joint assembly in the present disclosure; and

FIG. 7 is a perspective structural schematic view of a quick connect threaded part in the present disclosure.

In the drawings:

1. hollow hand-held portion; 2. pressure digital indicator; 3. airflow control valve sleeve; 4. quick fit interface; 5. inflation hose; 6. valve core joint assembly; 7. air relief valve; 8. dual end threaded part; 9. aluminum shell; 10. back seat; 11. face shell; 12. battery compartment; 13. compartment cap; 14. pressure sensor; 15. control board; 16. display screen; 17. battery assembling through-hole; 18. hollow connection terminal; 19. start switch; 20. backlight switch; 21. barrel; 22. control tube valve; 23. limiting clamp ring; 24. air hole; 25. quick connect threaded part; 26. air nozzle seat; 27. sealing rubber sheath; 28. valve threaded tube; 29. long tube core; 30. longitudinal groove; 31. annular groove.

### DETAILED DESCRIPTION OF EMBODIMENTS

Unless otherwise defined, all of the technical and scientific terms used herein have the same meanings as those commonly understood by those skilled in the art to which the present disclosure belongs; the terms used herein in the description of the present disclosure are merely for the purpose of describing embodiments, but are not intended to limit the present disclosure; the terms “comprise (include)” and “have” and any variations thereof in the description and the claims of the present disclosure as well as the above description of the drawings are intended to be non-exclusive. The terms “first”, “second” and the like in the description and the claims or the drawings of the present disclosure are used to distinguish different objects, rather than describing a specific order.

The phrase “embodiments” mentioned in the text means that specific features, structures or characteristics described in conjunction with the embodiments may be included in at least one embodiment of the present disclosure. This phrase appearing in various positions of the description does not necessarily refer to the same embodiment or an independent or alternative embodiment that is mutually exclusive with another embodiment. Those skilled in the art could understand, in explicit and implicit manners, that an embodiment described herein may be combined with another embodiment.

In order to achieve the above objective, the embodiments of the present disclosure provide a pressure monitor for vehicle tire inflation, aiming at solving the problems of certain potential safety hazards and shortened service life due to that in an inflation process of the existing vehicle tires, the pressure in the tires may be too high or too low and difficult to manage and control.

In some embodiments, a pressure monitor for vehicle tire inflation may include a hollow hand-held portion 1, a pressure digital indicator 2, an airflow control valve sleeve 3 and an air relief valve 7, wherein a top end of the hollow hand-held portion 1 is threadably provided with the pressure digital indicator 2, a bottom end of the hollow hand-held portion 1 is provided with a dual end threaded part 8, a lower portion of the dual end threaded part 8 is threadably provided with the airflow control valve sleeve 3, and the air relief valve 7 is provided on an outer side of an upper portion of the hollow hand-held portion 1. In this way, an inflation process of the tire can be monitored in real time by the pressure digital indicator 2, when the pressure in the tire is too high, the pressure in the tire is released by pressing the air relief valve 7, to reach a customized value of the inflation pressure, and when the pressure reaches a preset value, the inflation is stopped by the airflow control valve sleeve 3, so that the airflow pressure in the inflation process is accurately managed and controlled in real time, and the service life and inflation safety of the tire are guaranteed.

In some embodiments, the above pressure monitor for vehicle tire inflation further includes a quick fit interface 4 configured to be connected to an outside air pump, wherein an end of the airflow control valve sleeve 3 is provided with the quick fit interface 4.

In some embodiments, the above pressure monitor for vehicle tire inflation further includes an inflation hose 5, wherein the inflation hose 5 is hermetically connected and provided at one side of a top portion of the hollow hand-held portion 1.

In some embodiments, the above pressure monitor for vehicle tire inflation further includes a valve core joint assembly 6 configured to be connected to an air nozzle of a vehicle tire, wherein an end of the inflation hose 5 is provided with a quick connect threaded part 25, and the valve core joint assembly 6 is provided at an end of the quick connect threaded part 25.

In some embodiments, the above pressure digital indicator 2 includes an aluminum shell 9, a back seat 10, a face shell 11, a pressure sensor 14, a control board 15 and a display screen 16, wherein the back seat 10 and the face shell 11 are provided in the aluminum shell 9, the face shell 11 is tightly connected to the back seat, the control board 15 is provided in the back seat 10, a hollow connection terminal 18 configured to communicate with the hollow hand-held portion 1 is provided at a bottom end of the aluminum shell 9, the pressure sensor 14 is provided in the hollow connection terminal 18, and the display screen 16 is provided at an upper portion of the face shell 11. Such structural configuration of the present disclosure makes the structure of the pressure monitor more compact, smaller and convenient to carry.

In some embodiments, the above pressure digital indicator 2 further includes a battery compartment 12 and a compartment cap 13, the battery compartment 12 is provided on a rear end surface of the back seat 10, a back surface of the aluminum shell 9 is provided with a battery assembling through-hole 17, and the compartment cap 13 that is detachable is provided on the battery assembling through-hole 17.

In some embodiments, the above face shell 11 is provided thereon with a start switch 19 and a backlight switch 20, and the start switch 19 is located at one side of the backlight switch 20. In some embodiments, a backlight lamp is provided at a bottom portion of the back seat 10, and the control board 15 is electrically connected to the pressure sensor 14, the start switch 19, the backlight switch 20, the backlight lamp and the display screen 16.

In some embodiments, the above airflow control valve sleeve 3 includes a barrel 21, a control tube valve 22, a spring and a limiting clamp ring 23, wherein a top portion of the barrel 21 is provided with an annular groove 31, the limiting clamp ring 23 is sleeved in the annular groove 31, the control tube valve 22 is sleeved outside the barrel 21, and the barrel 21 is provided therein with the spring configured to abut and push the control tube valve 22.

In some embodiments, an inner side of an upper portion of the above barrel 21 is provided with an inner thread, and the inner thread of the barrel 21 is hermetically connected with the dual end threaded part 8, thus better achieving airtightness, so as to avoid unstable pressure control caused by air leakage.

In some embodiments, the above pressure monitor for vehicle tire inflation further includes a quick fit interface 4, wherein an end of the airflow control valve sleeve 3 is provided with the quick fit interface 4, and an end of the barrel 21 away from the top portion is connected to the quick fit interface 4.

In some embodiments, a side wall of a lower portion of the above barrel 21 is provided with an air hole 24, and a lower portion of an inner wall of the control tube valve 22 is provide with a sealing ring configured to control opening and closing of the air hole 24, wherein the control tube valve 22 is configured to be pushed downwards to close the air hole 24.

In some embodiments, the above valve core joint assembly 6 includes an air nozzle seat 26, a sealing rubber sheath 27 and a valve threaded tube 28, the quick connect threaded part 25 is hermetically threaded with one end of the air nozzle seat 26, and the other end of the air nozzle seat 26 is integrally connected to a long tube core 29 provided with a longitudinal groove 30.

In some embodiments, the sealing rubber sheath 27 is sleeved over the above long tube core 29, and the valve threaded tube 28 is sleeved over an outer side surface of the sealing rubber sheath 27.

In some embodiments, the above hollow hand-held portion 1 is made of an aluminum alloy.

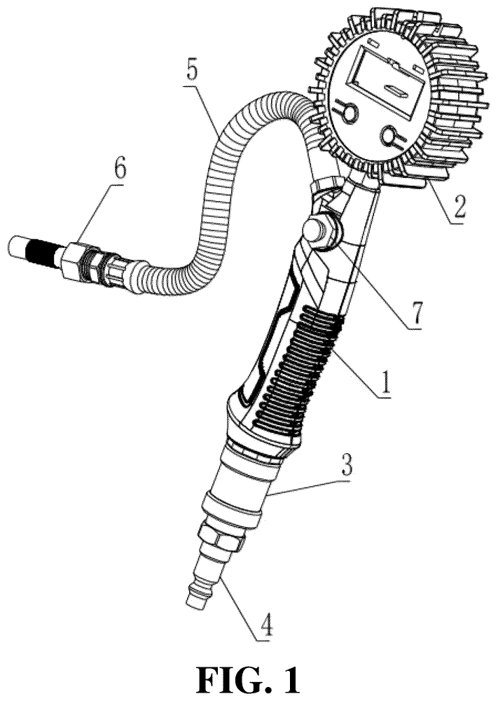

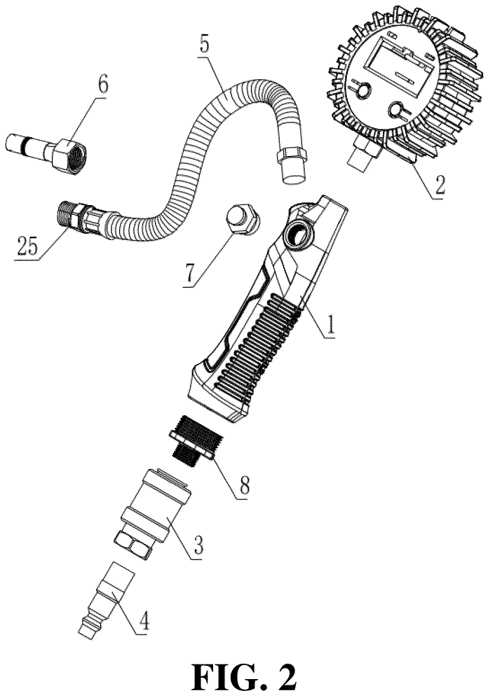

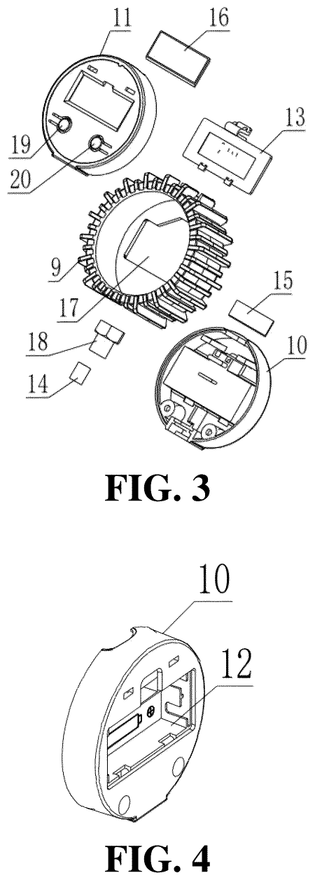

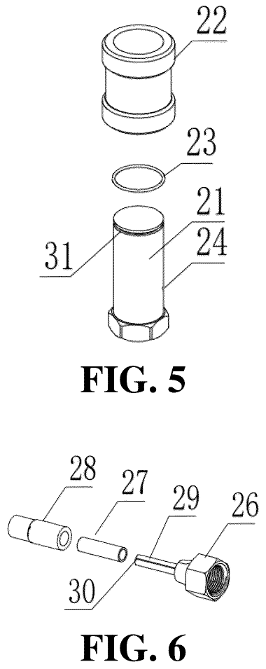

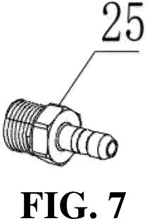

Referring to FIGS. 1-7, the embodiments of the present disclosure provide a pressure monitor for vehicle tire inflation, including a hollow hand-held portion 1, a pressure digital indicator 2, an airflow control valve sleeve 3, a quick fit interface 4, an inflation hose 5, a valve core joint assembly 6 and an air relief valve 7. A top end of the hollow hand-held portion 1 is threadably provided with the pressure digital indicator 2, and a bottom end of the hollow hand-held portion 1 is provided with a dual end threaded part 8. A lower portion of the dual end threaded part 8 is threadably provided with the airflow control valve sleeve 3. An end of the airflow control valve sleeve 3 is provided with a quick fit interface 4. The inflation hose 5 is hermetically connected and provided at one side of a top portion of the hollow hand-held portion 1. An end of the inflation hose 5 is provided with a quick connect threaded part 25. The valve core joint assembly 6 is provided at an end of the quick connect threaded part 25. The air relief valve 7 is provided on an outer side of an upper portion of the hollow hand-held portion 1.

In the present embodiment, the hollow hand-held portion I made of an aluminum alloy is held with a hand, to connect the quick fit interface 4 with an outside air pump. The valve core joint assembly 6 is connected to an air nozzle of a vehicle tire. Air supplied by the air pump enters the hollow hand-held portion 1 through the quick fit interface 4, and enters the vehicle tire from the valve core joint assembly 6 through the inflation hose 5 made of soft rubber, thus forming quick connection and inflating. In a process of inflation, when a pressure value displayed by the pressure digital indicator 2 reaches a preset pressure threshold, the airflow control valve sleeve 3 is manually pushed downwards so that air intake can be stopped, thus the pressure value of inflation can be customized, and can be monitored in time through the displayed pressure value. When the pressure value displayed by the pressure digital indicator 2 exceeds a preset pressure threshold, the air relief valve 7 is pressed to make the airflow to be discharged outwards from the air relief valve 7, so that an operation can be performed in time when the pressure is too high.

Further, the pressure digital indicator 2 includes an aluminum shell 9, a back seat 10, a face shell 11, a battery compartment 12, a compartment cap 13, a pressure sensor 14, a control board 15 and a display screen 16. The back seat 10 and the face shell 11 are provided in the aluminum shell 9. The face shell 11 is tightly connected to the back seat 10. The control board 15 is provided in the back seat 10. The battery compartment 12 is provided on a rear end surface of the back seat 10. The back surface of the aluminum shell 9 is provided with a battery assembling through-hole 17. The compartment cap 13 that is detachable is provided on the battery assembling through-hole 17. A hollow connection terminal 18 configured to communicate with the hollow hand-held portion 1 is provided at a bottom end of the aluminum shell 9. The pressure sensor 14 is provided in the hollow connection terminal 18. The face shell 11 is provided thereon with a start switch 19 and a backlight switch 20, wherein the start switch 19 is located at one side of the backlight switch 20. The display screen 16 is provided at an upper portion of the face shell 11. A backlight lamp is provided at a bottom portion of the back seat 10. The control board 15 is electrically connected to the pressure sensor 14, the start switch 19, the backlight switch 20, the backlight lamp and the display screen 16.

In the present embodiment, the pressure sensor 14 is used to collect magnitude of the pressure of the airflow in the hollow hand-held portion 1 in a process of inflation, and the pressure is processed by the control board 15 and then displayed on the display screen 16, so that users can timely watch and operate. In the above, the start switch 19 is used for turning on the pressure digital indicator 2, and the backlight lamp is turned on by pressing the backlight switch 20, so as to facilitate lighting during the inflation at night.

Further, the airflow control valve sleeve 3 includes a barrel 21, a control tube valve 22, a spring and a limiting clamp ring 23. An inner side of an upper portion of the barrel 21 is provided with an inner thread, wherein the inner thread of the barrel 21 is hermetically connected with the dual end threaded part 8. A top portion of the barrel 21 is provided with an annular groove 31, and the limiting clamp ring 23 is sleeved in the annular groove 31. The other end of the barrel 21 is connected to the quick fit interface 4. The control tube valve 22 is sleeved outside the barrel 21. The barrel 21 is provided therein with the spring configured to abut and push the control tube valve 22. A side wall of a lower portion of the barrel 21 is provided with an air hole 24, and a lower portion of an inner wall of the control tube valve 22 is provided with a sealing ring configured to control opening and closing of the air hole 24, wherein the control tube valve 22 is pushed downwards to close the air hole 24.

In the present embodiment, the limiting clamp ring 23 is used for limiting the control tube valve 22 to move up and down to open and close the air hole 24, and the sealing ring is moved down to slide to a position of the air hole 24 to block the air hole 24 and stop the air intake.

Further, the valve core joint assembly 6 includes an air nozzle seat 26, a sealing rubber sheath 27 and a valve threaded tube 28. The quick connect threaded part 25 is hermetically threaded with one end of the air nozzle seat 26, the other end of the air nozzle seat 26 is integrally connected to a long tube core 29 provided with a longitudinal groove 30, the sealing rubber sheath 27 is sleeved over the long tube core 29, and the valve threaded tube 28 is sleeved over an outer side surface of the sealing rubber sheath 27.

In conclusion, the present disclosure provides a pressure monitor for vehicle tire inflation, which is connected to the outside air pump through the quick fit interface, wherein the valve core joint assembly is connected to the air nozzle of the tire, the pressure digital indicator is used to monitor the inflation process, and when the pressure is too high, the tire is deflated by pressing the air relief valve, to reach a customized value of the inflation pressure, and when the pressure reaches a preset value, the airflow is prevented from entering the barrel and the air intake is stopped, by pushing down the control tube valve, so that the airflow pressure in the inflation process can be accurately managed and controlled in real time, and the service life and inflation safety of the tire are guaranteed.

The technical principle of the present disclosure is described in the above in conjunction with embodiments, which are only preferred embodiments of the present disclosure. The scope of protection of the present disclosure is not limited to the above embodiments, and all of the technical solutions under the concept of the present disclosure belong to the scope of protection of the present disclosure. Other embodiments of the present disclosure conceivable to those skilled in the art without using any inventive efforts all fall within the scope of protection of the present disclosure.

What is claimed is:

1. A pressure monitor for vehicle tire inflation, comprising a hollow hand-held portion, a pressure digital indicator, an airflow control valve sleeve and an air relief valve, wherein a top end of the hollow hand-held portion is threadably provided with the pressure digital indicator, a bottom end of the hollow hand-held portion is provided with a dual end threaded part, a lower portion of the dual end threaded part is threadably provided with the airflow control valve sleeve, and the air relief valve is provided on an outer side of an upper portion of the hollow hand-held portion.

2. The pressure monitor for vehicle tire inflation according to claim 1, further comprising a quick fit interface configured to be connected to an outside air pump, wherein an end of the airflow control valve sleeve is provided with the quick fit interface.

3. The pressure monitor for vehicle tire inflation according to claim 1, further comprising an inflation hose, wherein the inflation hose is hermetically connected and provided at one side of a top portion of the hollow hand-held portion.

4. The pressure monitor for vehicle tire inflation according to claim 3, further comprising a valve core joint assembly configured to be connected to an air nozzle of a vehicle tire, wherein an end of the inflation hose is provided with a quick connect threaded part, and the valve core joint assembly is provided at an end of the quick connect threaded part.

5. The pressure monitor for vehicle tire inflation according to claim 1, wherein the pressure digital indicator comprises an aluminum shell, a back seat, a face shell, a pressure sensor, a control board and a display screen, wherein the back seat and the face shell are provided in the aluminum shell, the face shell is tightly connected to the back seat, the control board is provided in the back seat, a hollow connection terminal configured to communicate with the hollow hand-held portion is provided at a bottom end of the aluminum shell, the pressure sensor is provided in the hollow connection terminal, and the display screen is provided at an upper portion of the face shell.

6. The pressure monitor for vehicle tire inflation according to claim 5, wherein the pressure digital indicator further comprises a battery compartment and a compartment cap, the battery compartment is provided on a rear end surface of the back seat, a back surface of the aluminum shell is provided with a battery assembling through-hole, and the compartment cap that is detachable is provided on the battery assembling through-hole.

7. The pressure monitor for vehicle tire inflation according to claim 5, wherein the face shell is provided with a start switch and a backlight switch, and the start switch is located at one side of the backlight switch.

8. The pressure monitor for vehicle tire inflation according to claim 7, wherein a backlight lamp is provided at a bottom portion of the back seat, and the control board is electrically connected to the pressure sensor, the start switch, the backlight switch, the backlight lamp and the display screen.

9. The pressure monitor for vehicle tire inflation according to claim 1, wherein the airflow control valve sleeve comprises a barrel, a control tube valve, a spring and a limiting clamp ring, wherein a top portion of the barrel is provided with an annular groove, the limiting clamp ring is sleeved in the annular groove, the control tube valve is sleeved outside the barrel, and the barrel is provided therein with the spring configured to abut and push the control tube valve.

10. The pressure monitor for vehicle tire inflation according to claim 9, wherein an inner side of an upper portion of the barrel is provided with an inner thread, and the inner thread of the barrel is hermetically connected with the dual end threaded part.

11. The pressure monitor for vehicle tire inflation according to claim 9, further comprising a quick fit interface, wherein an end of the airflow control valve sleeve is provided with the quick fit interface, and an end of the barrel away from the top portion is connected to the quick fit interface.

12. The pressure monitor for vehicle tire inflation according to claim 9, wherein a side wall of a lower portion of the barrel is provided with an air hole, and a lower portion of an inner wall of the control tube valve is provide with a sealing ring configured to control opening and closing of the air hole, wherein the control tube valve is configured to be pushed downwards to close the air hole.

13. The pressure monitor for vehicle tire inflation according to claim 1, wherein the valve core joint assembly comprises an air nozzle seat, a sealing rubber sheath and a valve threaded tube, the quick connect threaded part is hermetically threaded with one end of the air nozzle seat, and the other end of the air nozzle seat is integrally connected to a long tube core provided with a longitudinal groove.

14. The pressure monitor for vehicle tire inflation according to claim 13, wherein the sealing rubber sheath is sleeved over the long tube core, and the valve threaded tube is sleeved over an outer side surface of the sealing rubber sheath.

15. The pressure monitor for vehicle tire inflation according to claim 1, wherein the hollow hand-held portion is made of an aluminum alloy.

16. A pressure monitor for vehicle tire inflation, comprising a hollow hand-held portion, a pressure digital indicator, an airflow control valve sleeve, a quick fit interface, an inflation hose, a valve core joint assembly and an air relief valve, wherein a top end of the hollow hand-held portion is threadably provided with the pressure digital indicator, a bottom end of the hollow hand-held portion is provided with a dual end threaded part, a lower portion of the dual end threaded part is threadably provided with the airflow control valve sleeve, an end of the airflow control valve sleeve is provided with a quick fit interface, the inflation hose is hermetically connected and provided at one side of a top portion of the hollow hand-held portion, an end of the inflation hose is provided with a quick connect threaded part, the valve core joint assembly is provided at an end of the quick connect threaded part, and the air relief valve is provided on an outer side of an upper portion of the hollow hand-held portion.

17. The pressure monitor for vehicle tire inflation according to claim 16, wherein the pressure digital indicator comprises an aluminum shell, a back seat, a face shell, a battery compartment, a compartment cap, a pressure sensor, a control board and a display screen, wherein the back seat and the face shell are provided in the aluminum shell, the face shell is tightly connected to the back seat, the control board is provided in the back seat, the battery compartment is provided on a rear end surface of the back seat, a back surface of the aluminum shell is provided with a battery assembling through-hole, the compartment cap that is detachable is provided on the battery assembling through-hole, a hollow connection terminal configured to communicate with the hollow hand-held portion is provided at a bottom end of the aluminum shell, the pressure sensor is provided in the hollow connection terminal, the face shell is provided with a start switch and a backlight switch, the start switch is located at one side of the backlight switch, the display screen is provided at an upper portion of the face shell, a backlight lamp is provided at a bottom portion of the back seat, and the control board is electrically connected to the pressure sensor, the start switch, the backlight switch, the backlight lamp and the display screen.

18. The pressure monitor for vehicle tire inflation according to claim 16, wherein the airflow control valve sleeve comprises a barrel, a control tube valve, a spring and a limiting clamp ring, wherein an inner side of an upper portion of the barrel is provided with an inner thread, the inner thread of the barrel is hermetically connected with the dual end threaded part, a top portion of the barrel is provided with an annular groove, the limiting clamp ring is sleeved in the annular groove, an end of the barrel away from the top portion is connected to the quick fit interface, the control tube valve is sleeved outside the barrel, the barrel is provided therein with the spring configured to abut and push the control tube valve, a side wall of a lower portion of the barrel is provided with an air hole, and a lower portion of an inner wall of the control tube valve is provide with a sealing ring configured to control opening and closing of the air hole, wherein the control tube valve is configured to be pushed downwards to close the air hole.

19. The pressure monitor for vehicle tire inflation according to claim 16, wherein the valve core joint assembly comprises an air nozzle seat, a sealing rubber sheath and a valve threaded tube, the quick connect threaded part is hermetically threaded with one end of the air nozzle seat, the other end of the air nozzle seat is integrally connected to a long tube core provided with a longitudinal groove, the sealing rubber sheath is sleeved over the long tube core, and the valve threaded tube is sleeved over an outer side surface of the sealing rubber sheath.

20. The pressure monitor for vehicle tire inflation according to claim 16, wherein the hollow hand-held portion is made of an aluminum alloy.
